(19) United States
(12) Patent Application Publication
(10) Pub. No.: US 2010/0180092 A1
(43) Pub. Date: Jul. 15, 2010

(54) METHOD AND SYSTEM OF VISUALIZATION OF CHANGES IN ENTITIES AND THEIR RELATIONSHIPS IN A VIRTUAL DATACENTER THROUGH A LOG FILE

(75) Inventors: Subash RAJAA, Pune (IN); Mangesh PANGARKAR, Pune (IN)

Correspondence Address: VMWARE, INC., DARRYL SMITH, 3401 Hillview Ave., PALO ALTO, CA, 94304, US

(73) Assignee: VMWARE, INC., Palo Alto, CA (US)

(21) Appl. No.: 12/351,022

(22) Filed: Jan. 9, 2009

(51) Int. Cl. G06F 12/16; G06F 12/00; G06F 17/30

(52) U.S. Cl. 711/162; 707/E17.01; 711/E12.001; 711/E12.103

(57) ABSTRACT

Disclosed are a method and system of visualization of changes in entities and their relationships in a virtual data center through a log file. In one embodiment, a machine-readable medium embodying a set of instructions is disclosed. Periodically a snapshot is captured from an application programming interface of a management server. The snapshot comprises of entities and relationships of a virtual datacenter. An information of the snapshot is identified. The identified information is relevant to visualization of a state of the virtual datacenter in a log file. An activity of a change in entities and relationships of the virtual datacenter is tracked. An event is registered with the management server through the application programming interface. Based on the event a corresponding delta operation is created and added to the log file.

### FIELD OF TECHNOLOGY

Disclosed are a method and system of visualization of changes in entities and their relationships in a virtual data center through a log file.

### BACKGROUND

A virtual datacenter may comprise of entities like a physical host, a virtual machine, a Storage Area Network (SAN), a network, an application running inside the virtual machine, etc. A configuration involving the various entities of the virtual datacenter and their relationships may undergo considerable changes over a period of time. For example, there may be a change in the configuration when a virtual machine is added or deleted. Similarly, there may be a change in the configuration when a datastore is created or deleted. There may be a requirement to review the changes in entities of the virtual data center and their relationships that may have occurred at a specific time in a history of the virtual datacenter.

A network administrator may manually browse through numerous log entries to review the changes that may have occurred at the specific time in the history of the virtual datacenter. Manually browsing through the numerous log entries may be time consuming and confusing because there may be large number of logs in the history of the virtual datacenter. In addition, manually reviewing the numerous log entries to find relevant information may be time consuming, cumbersome, complicated, and/or tedious.

### SUMMARY

Disclosed are a method and system of visualization of changes in entities and their relationships in a virtual data center through a log file. In one aspect, a machine-readable medium embodying a set of instructions is disclosed. Periodically a snapshot is captured from an application programming interface of a management server. The snapshot comprises representation of entities and relationships of a virtual datacenter at a point-in-time of the virtual datacenter. An information of the snapshot is identified. The identified information is relevant to visualization of a state of the virtual datacenter in a log file. An activity of a change in entities and relationships of the virtual datacenter is tracked. An event is registered with the management server through the application programming interface. Based on the event a corresponding delta operation is created and added to the log file

A visual representation of entities and relationships of the virtual datacenter at a required time is created by accessing a nearest snapshot to a required time from the log file. The delta operation is applied to this nearest snapshot. With this an entity and relationship state of the virtual datacenter at the required time is created. The created entity and relationship state is used to create a visual representation of the entities and relationships of the virtual data center at the required time.

In another aspect, a system is disclosed. The system includes a management server to periodically capture a snapshot of the virtual datacenter, to identify an information of the snapshot that is relevant to visualization of a state of the virtual datacenter in a log file, and to create a visual representation of the virtual datacenter at a required time. The visual representation of the virtual datacenter is created when a nearest snapshot to the required time is loaded from the log file and appended with a delta operation.

In another aspect, a machine-readable medium embodying a set of instructions is disclosed. When the set of instructions are executed by a machine, this execution causes the machine to perform a method. The method includes periodically capturing a snapshot comprising of entities and their relationships of a virtual datacenter. Information of the snapshot that is relevant to visualization of a state of the virtual datacenter in a log file is identified. A visual representation of the virtual datacenter at a required time is created when a nearest snapshot to the required time is loaded from the log file and appended with delta operation. An activity of change in the virtual datacenter is communicated to a management server.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a management server communicating with a virtual datacenter and a visual representation of a state of virtual datacenter, according to one or more embodiments.

FIG. 2 is an exploded view of the management server illustrated in FIG. 1, according to one or more embodiments.

FIG. 3 is a schematic view illustrating the content of the log file, according to one or more embodiments.

FIG. 4A is a user interface view illustrating the entities and their relationships of the virtual datacenter as on a required time, according to one or more embodiments.

FIG. 4B is a diagrammatic view illustrating a user interface view, according to one or more embodiments.

FIG. 5 is a diagrammatic system view of a data processing system in which any of the embodiments disclosed herein may be performed, according to one or more embodiments.

FIG. 6 is a schematic view illustrating creation of visual representation of a state of virtual datacenter at a required time, according to one or more embodiments.

FIG. 7 is a process flow illustrating creation of visual representation of changes in the virtual datacenter at a required time, according to one or more embodiments.

FIG. 8A is a process flow illustrating a method to track an event of a virtual datacenter and representing in a visual format, according to one or more embodiments.

FIG. 8B is the continuation of the process flow illustrated in FIG. 8A with additional embodiments, according to one or more embodiments

FIG. 9 is a process flow illustrating identification of a change relevant to visualization of the virtual datacenter and communicating the change to the management server, according to one or more embodiments.

Other features of the present embodiments will be apparent from the accompanying Drawings and from the Detailed Description that follows.

### DETAILED DESCRIPTION

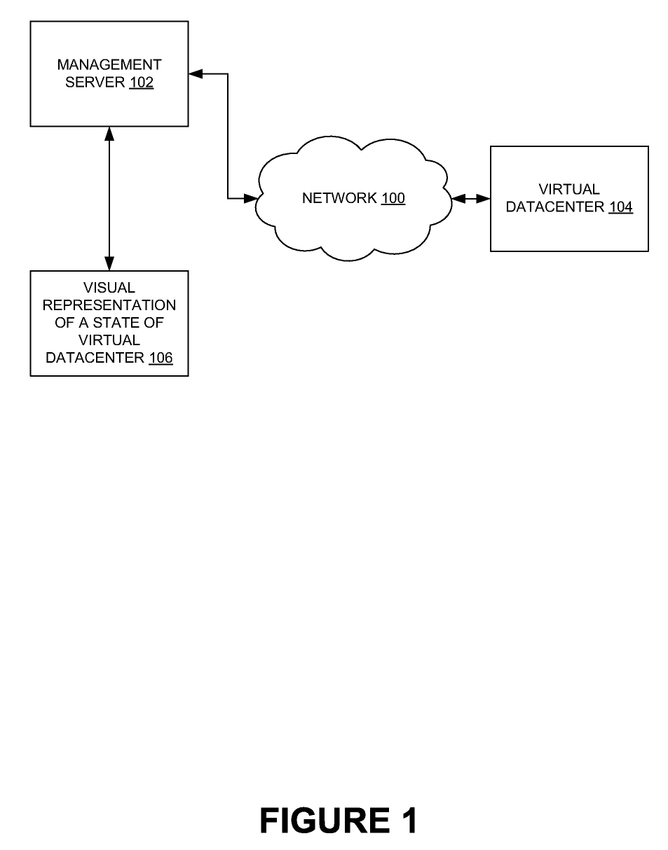

FIG. 1 is a system view of a management server communicating with a virtual datacenter and a visual representation of a state of virtual datacenter, according to one or more embodiments. Particularly, FIG. 1 illustrates a network 100, the management server 102, the virtual datacenter 104, and the visual representation of a state of virtual datacenter 106, according to one embodiment.

The network 100 (e.g., LAN, WAN, mobile, telecommunications, internet, intranet, WiFi and/or ZigBee network, etc.) may enable communication between the management server 102 and the virtual datacenter 104. The management server 102 may track the events occurring in the virtual datacenter and may provide the information relevant to visualization of the virtual datacenter 104 at a given time period. The virtual datacenter 104 may be a physical set of computer system and/or associated components (e.g., telecommunication, storage system, etc.). The visual representation of a state of virtual datacenter 106 may communicate with the management server 102 to provide a state of the virtual datacenter 104 in the form of chart, table, graph, etc.

In an example embodiment, the management server 102 may communicate to the virtual datacenter 104 through the network 100. The management server 102 may communicate to the visual representation of a state of virtual datacenter 106 to provide the information required for visualization of the state of the virtual datacenter 104.

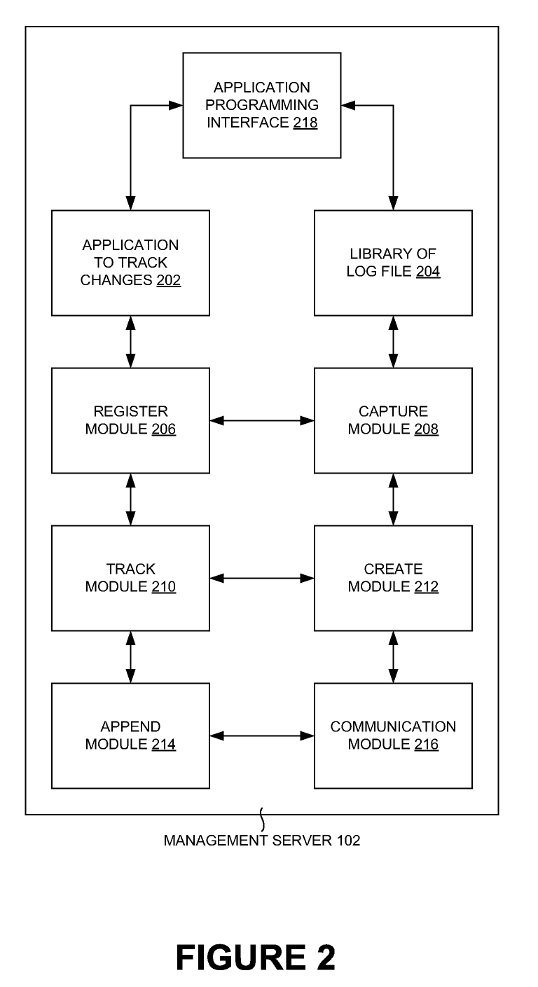

In one embodiment, the snapshot of the virtual datacenter 104 may be captured (e.g., using a capture module 208 of FIG. 2). The delta operation corresponding to the activity occurring in the virtual datacenter 104 may be generated. The virtual datacenter 104 may be a collection of a physical set of a host machine, datastore, network, a virtual machine, a CPU, a storage, and/or a resource pool.

The change in the virtual datacenter 104 may be a change to a host machine, a virtual machine, connection of the virtual machine to the host machine and/or a network configuration. The visual representation of the virtual datacenter (e.g., visual representation of a state of virtual datacenter 106) may be a chart, a table, and/or a graph. The snapshot of applications running on virtual machines in the virtual datacenter 104 may be captured.

Information of the snapshot that is relevant to visualization of a state of the virtual datacenter 104 may be identified in a log file by the management server 102.

The management server 102 may create (e.g., using a create module 212 of FIG. 2) a visual representation of the virtual datacenter 104 using a log file. The virtual datacenter 104 may communicate an activity of a change in the virtual data center to the management server 102 through the network 100. The snapshot may be a point-in-time representation of entities and relationships in the virtual data center. The snapshot may include information of applications running on virtual machines in the virtual datacenter 104.

It should be noted that a snapshot may primarily comprise of the information of a host, a virtual machine, a data store, a relationship between the virtual machine and a host machine, a relationship between host and the datastore, a relationship between virtual machine and the datastore, a virtual network, and a relationship between the virtual machine and the virtual network. In addition, a snapshot may be extended to include saved copies of virtual machine memory including a content of a memory byte, a hardware register and a status indicator.

FIG. 2 is an exploded view of the management server illustrated in FIG. 1, according to one or more embodiments. Particularly, FIG. 2 illustrates an application to track changes 202, a library of log file 204, a register module 206, the capture module 208, a track module 210, the create module 212, an append module 214, a communication module 216, and an application programming interface (API) 218, according to one embodiment.

The application to track changes 202 may be a software that may track change in the configuration of the virtual datacenter 104. The library of log file 204 may be a store of the log files containing the information relevant to visualization of the state of the virtual datacenter 104. The register module 206 may register the event (e.g., addition and/or deletion of a virtual machine, change in a network configuration, allocation of resource pools, etc.) occurring in the virtual datacenter 104. The capture module 208 may capture the snapshot of the virtual datacenter 104 that may provide information comprising the entities and relationships of the datacenter at a point-in-time of virtual datacenter 104.

The track module 210 may track an activity of change (e.g., addition and/or deletion of virtual machine, association and/or disassociation of the virtual machine with a data store, etc.) in the virtual datacenter. The create module 212 may create a visual representation of the virtual datacenter using the information of the log file. The append module 214 may append the information of delta operation to a log file. The communication module 216 may communicate with the virtual datacenter 104 to provide information of an activity of change in the virtual datacenter 104 (e.g., a change in configuration of a virtual machine, addition of a resource pool, a change in network configuration, etc.) to the management server 102. The API 218 may be a set of functions, procedures, methods and/or protocols that an operating system, library or service provides to support requests made by a computer program.

In an example embodiment, the application to track changes 202 may communicate to API 218 and the register module 206. The register module 206 may communicate with the track module 210 and the capture module 208. The track module may communicate with the append module 214 and the create module 212. The communication module 216 may communicate with the append module 214 and the create module 212. The create module 212 may communicate with the track module 210 and the capture module 208. The capture module 208 may communicate with the register module 206 and the library of log file 204. The library of log file 204 may communicate with the capture module 208 and the API 218.

In one embodiment, a snapshot including entities and relationships of the virtual datacenter 104 may be periodically captured from an application programming interface 218 of the management server 102. An activity of a change in entities and relationships of the virtual datacenter 104 may be tracked (e.g., using the track module 210). An event may be registered (using the register module 206) with the management server 102 through the application programming interface 218.

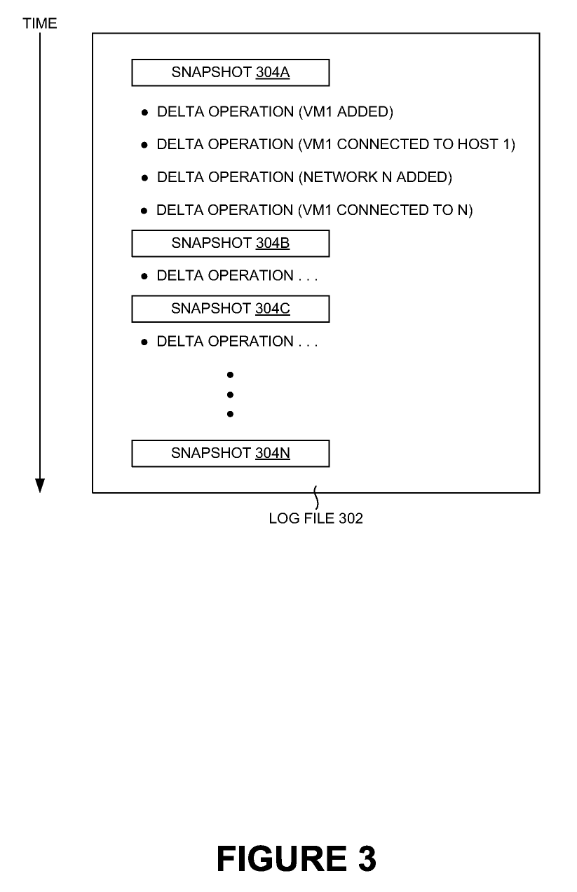

FIG. 3 is a schematic view illustrating the content of the log file, according to one or more embodiments. Particularly, FIG. 3 illustrates the log file 302, and a snapshot 304A-N, according to one embodiment.

The log file 302 may include the snapshot 304A-N and the delta operations that may provide information relevant to visualization of the state of the virtual datacenter.

In an example embodiment, the log file 302 may consist of the snapshot 304A-N comprising entities and relationships of virtual data center at various points in time.

In one embodiment, information of the snapshot 304A-N that may be relevant to visualization of a state of the virtual datacenter 104 may be identified in the log file 302. Delta operation may be created based on the events occurring in virtual datacenter and added to log file. A nearest snapshot to a required time may be accessed from the log file 302. The delta operation may be applied to the nearest snapshot.

The snapshot 304A-N may be taken on a periodic basis at a threshold interval, and the log file 302. The delta operation may be an activity of each of the event in the virtual datacenter 104.

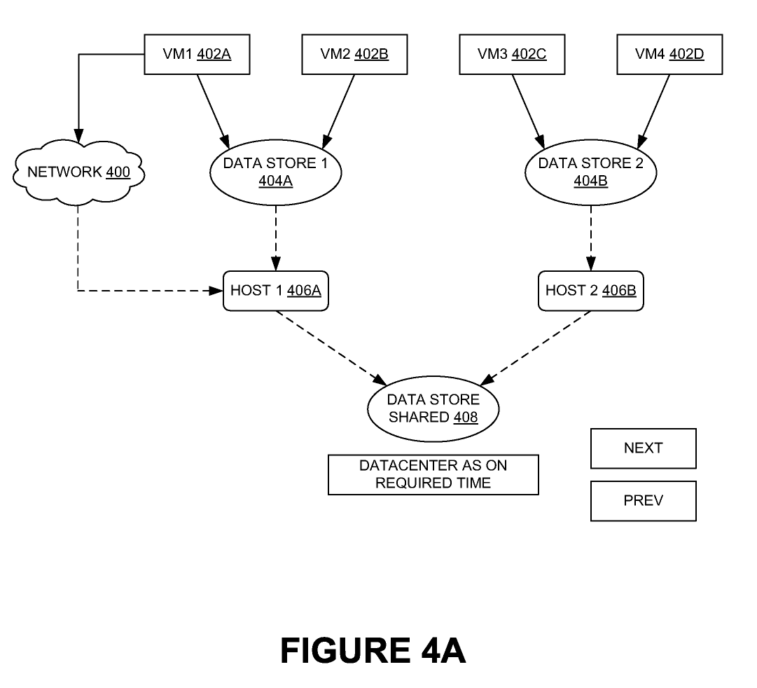

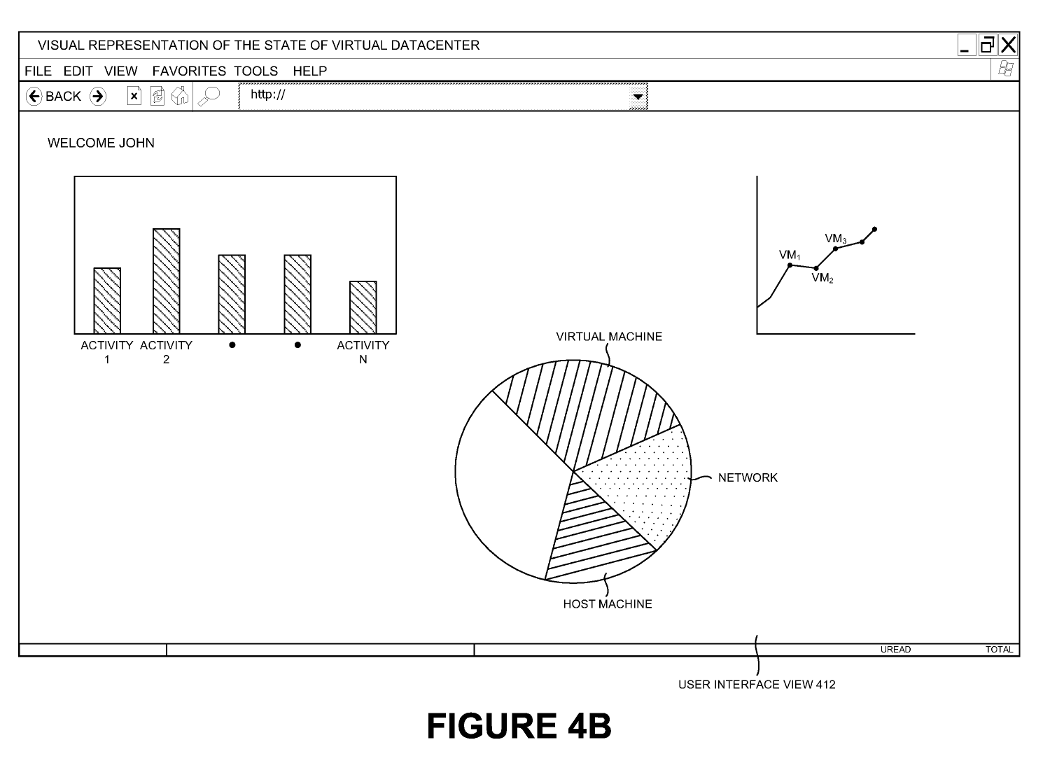

FIG. 4A is a user interface view illustrating the entities and their relationship of the virtual datacenter as on a required time, according to one or more embodiments. Particularly, FIG. 4A illustrates a network 400, a VM1 402A, a VM2 402B, a VM3 402C, a VM4 402D, a datastore1 404A, a datastore2 404B, a host1 406A, a host2 406B, and a datastore shared 408, according to one or more embodiments.

The network 400 may be a LAN, WAN, mobile, telecommunications, internet, intranet, WiFi and/or ZigBee network, etc. in the virtual datacenter. The VM1 402A, the VM2 402B, the VM3 402C, the VM4 402D may be the virtual machines (a software implementation of a machine (computer) that may execute programs like a real machine) of the virtual datacenter 104. The data store1 404A and the data store2 404B may be a storage for virtual disks. The data store1 404A and the data store2 404B may also be an integration of data (e.g., information) from multiple sources to make analysis and/or reporting easier. The host1 406A and the host2 406B may be a computer associated with a network, online services, etc. The data store shared 408 may be a data store shared by the different hosts of the virtual datacenter 104.

In an example embodiment, the VM1 402A may be connected to the network 400 and the datastore1 404A. The VM2 402B may be connected to the datastore1 404A. The VM3 402C and the VM4 402D may be connected to the datastore2 404B. The datastore1 404A may be connected to the network 400, the datastore1 404A, and the datastore shared 408. The host2 406B may be connected to the datastore2 404B, and the datastore shared 408.

FIG. 4B is a diagrammatic view illustrating a user interface view, according to one or more embodiments. Particularly, FIG. 4 illustrates a user interface view 412, according to one embodiment.

The user interface view 412 may provide a graphical view of a state of the virtual datacenter 104 at a given time period.

In an example embodiment, the user interface view 412 may represent the visualization of the state of the virtual datacenter 104. The visual representation may be a graphical view illustrating state of host machine, network, virtual machine and an activity1-N at a given time period.

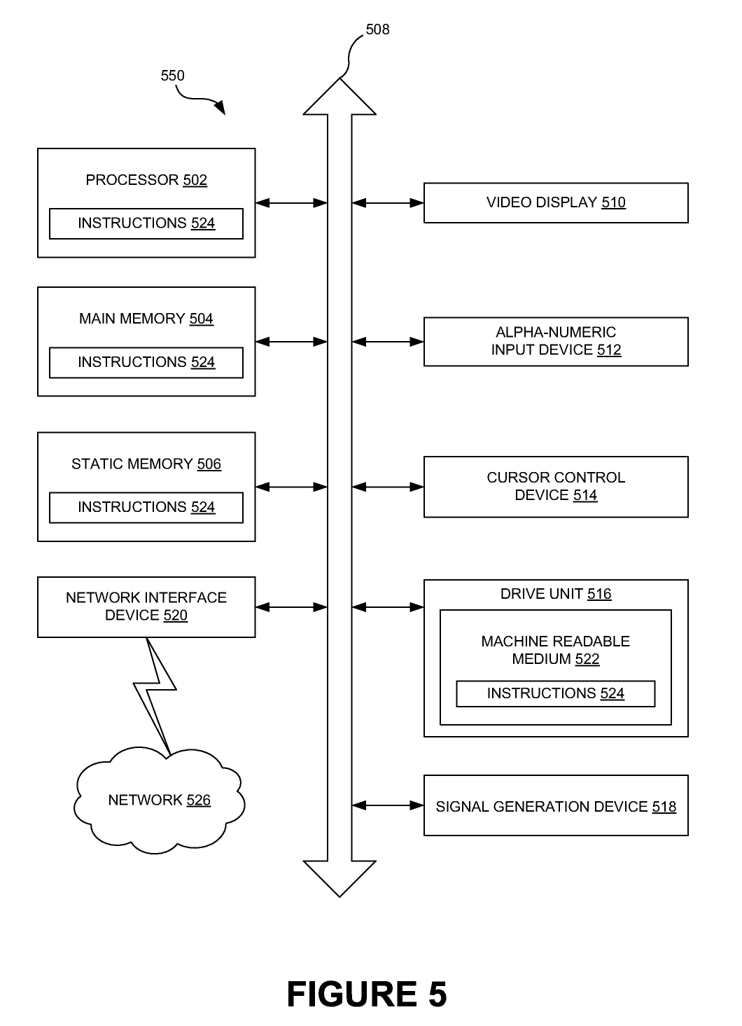

FIG. 5 is a diagrammatic system view of a data processing system in which any of the embodiments disclosed herein may be performed, according to one or more embodiments. Particularly, the diagrammatic system view 500 of FIG. 5 illustrates a processor 502, a main memory 504, a static memory 506, a bus 508, a video display 510, an alpha-numeric input device 512, a cursor control device 514, a drive unit 516, a signal generation device 518, a network interface device 520, a machine readable medium 522, instructions 524, and a network 526, according to one embodiment.

The diagrammatic system view 500 may indicate a personal computer and/or the data processing system in which one or more operations disclosed herein are performed. The processor 502 may be a microprocessor, a state machine, an application specific integrated circuit, a field programmable gate array, etc. (e.g., Intel® Pentium® processor). The main memory 504 may be a dynamic random access memory and/or a primary memory of a computer system.

The static memory 506 may be a hard drive, a flash drive, and/or other memory information associated with the data processing system. The bus 508 may be an interconnection between various circuits and/or structures of the data processing system. The video display 510 may provide graphical representation of information on the data processing system. The alpha-numeric input device 512 may be a keypad, a keyboard and/or any other input device of text (e.g., a special device to aid the physically handicapped).

The cursor control device 514 may be a pointing device such as a mouse. The drive unit 516 may be the hard drive, a storage system, and/or other longer term storage subsystem. The signal generation device 518 may be a bios and/or a functional operating system of the data processing system. The network interface device 520 may be a device that performs interface functions such as code conversion, protocol conversion and/or buffering required for communication to and from the network 526. The machine readable medium 522 may provide instructions on which any of the methods disclosed herein may be performed. The instructions 524 may provide source code and/or data code to the processor 502 to enable any one or more operations disclosed herein.

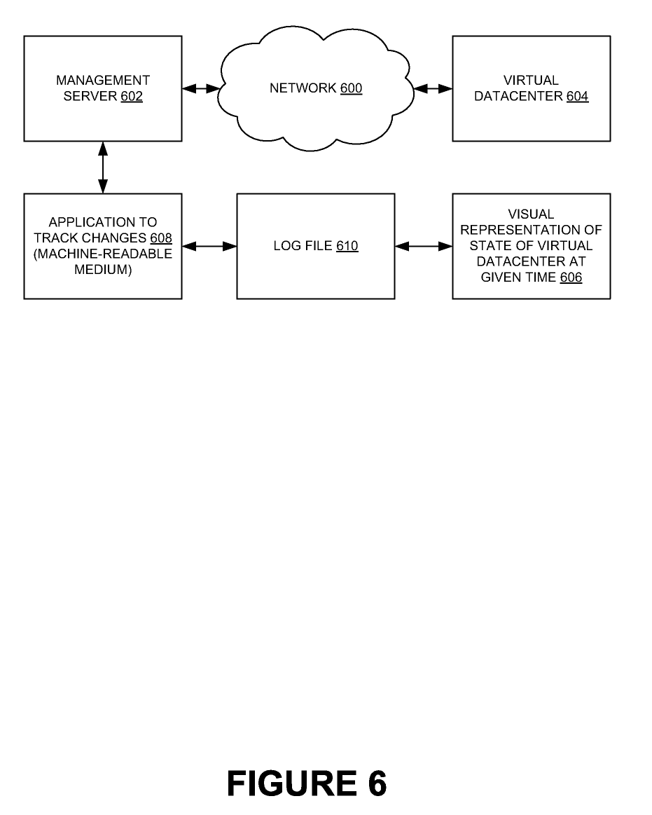

FIG. 6 is a schematic view illustrating creation of visual representation of a state of virtual datacenter at a given time, according to one or more embodiments. Particularly, FIG. 6 illustrates a network 600, a management server 602, a virtual datacenter 604, a visual representation of state of virtual datacenter at a given time 606, an application to track changes (machine-readable medium) 608, and a log file 610, according to one embodiment.

It should be noted that in one exemplary embodiment, applications deployed on the virtual machines may be tracked along with other objects previously mentioned. In addition, the method of creating a snapshot of the virtual data center may include an ability to revert to the snapshot. This method may include creating a repository of virtual machines in the data center. This may be called a ‘virtual machine repository’ (e.g., or virtual machine library). The virtual machine repository may be tracked to monitor all additions and/or deletions of virtual machines. The delta changes may be periodically saved in the datacenter with respect to the hosts at a configurable time interval. The snapshot may contain the actual virtual machine in the form of files, in the one exemplary embodiment. Later, users may be able to go back in time and restore a data center from the repository of snapshots at a given time T1, T2, etc. Reverting back in time may give a user an option to visualize the virtual machine environment in the past and/or in any environment.

The network 600 may be a LAN, WAN, mobile, telecommunications, internet, intranet, WiFi and/or ZigBee network, etc. The network 600 may enable communication between the management server 602 and the virtual datacenter 604. The management server 602 may track the events occurring in the virtual datacenter 604 and may provide the information relevant to visualization of the virtual datacenter 604 at a given time period. The virtual datacenter 604 may be a physical set of computer system and/or associated components (e.g., telecommunication, storage system, etc.). The visual representation of a state of virtual datacenter at a given time 606 may communicate with the log file 610 to obtain the information relevant to visualization. The application to track changes (machine-readable medium) 608 may be software that may track changes in the configuration of the virtual datacenter 104. The log file 610 may include the snapshot and the delta operations that may provide information relevant to visualization of the state of the virtual datacenter.

In an example embodiment, the management server 602 may communicate with the virtual datacenter 604 through the network 600. The management server 602 may communicate with the log file 610 through the application to track changes (machine-readable medium) 608. The visual representation of state of virtual datacenter at given time 606 may communicate with log file 610 to obtain the required information. Also, it should be mentioned that there may be two distinct type of entries in the log file 610, one called “snapshots” and the other called “delta entries.” The snapshot may be a representation of complete state at point-in-time of the dump operation, while delta entry may be incremental state changing operation.

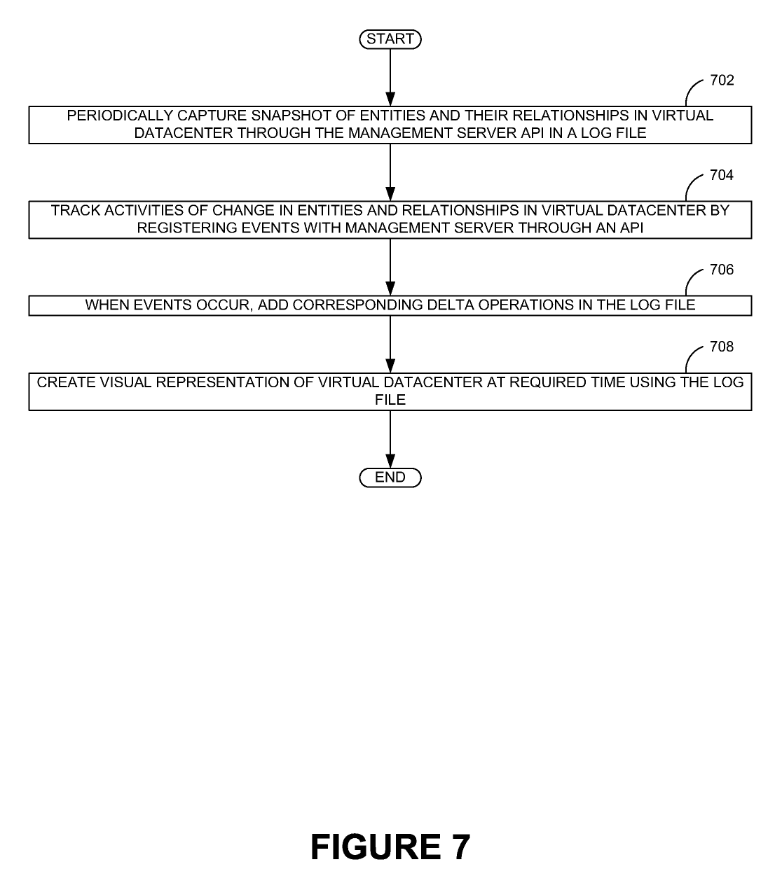

FIG. 7 is a process flow illustrating creation of visual representation of changes in the virtual datacenter at a time required time, according to one or more embodiments.

In operation 702 a snapshot including the entities and their relationships in the virtual datacenter 104 may be periodically captured through the API 218 of the management server 102 in a log file 302. In operation 704, activities of change in the entities and their relationships in the virtual datacenter may be tracked by registering events with the management server 102 through the API 218. In operation 706, when the events occur corresponding delta operations may be added in a log file (e.g., the log file 302 of FIG. 3). In operation 708 a visual representation of the virtual datacenter 104 may be created at a required time using the log file 302.

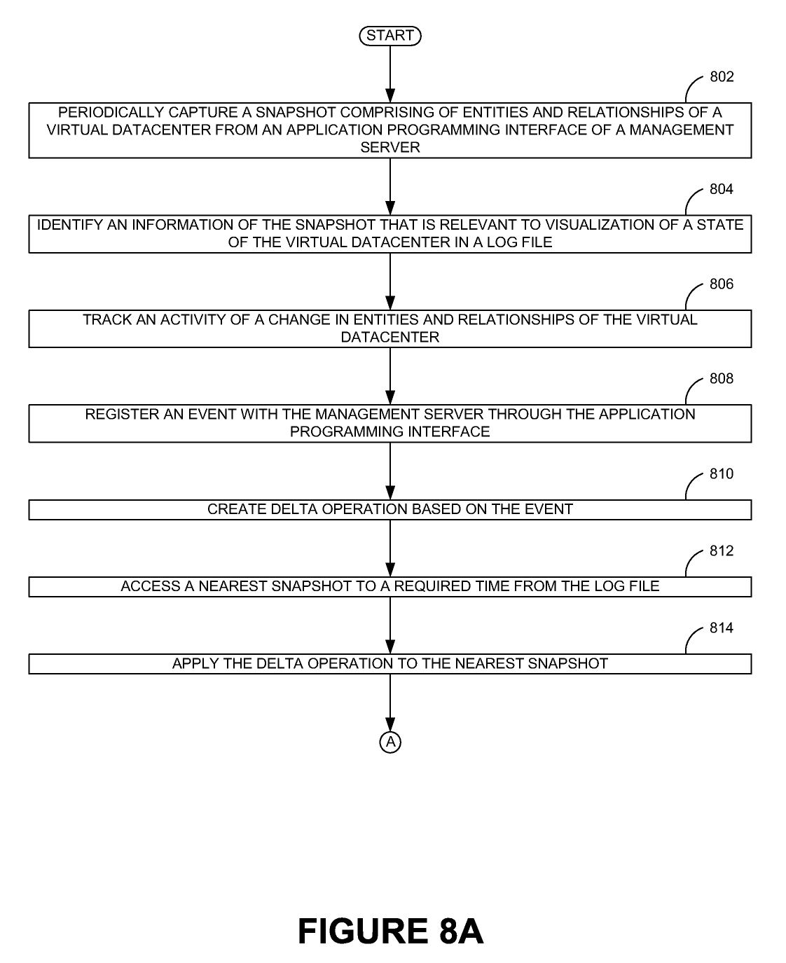

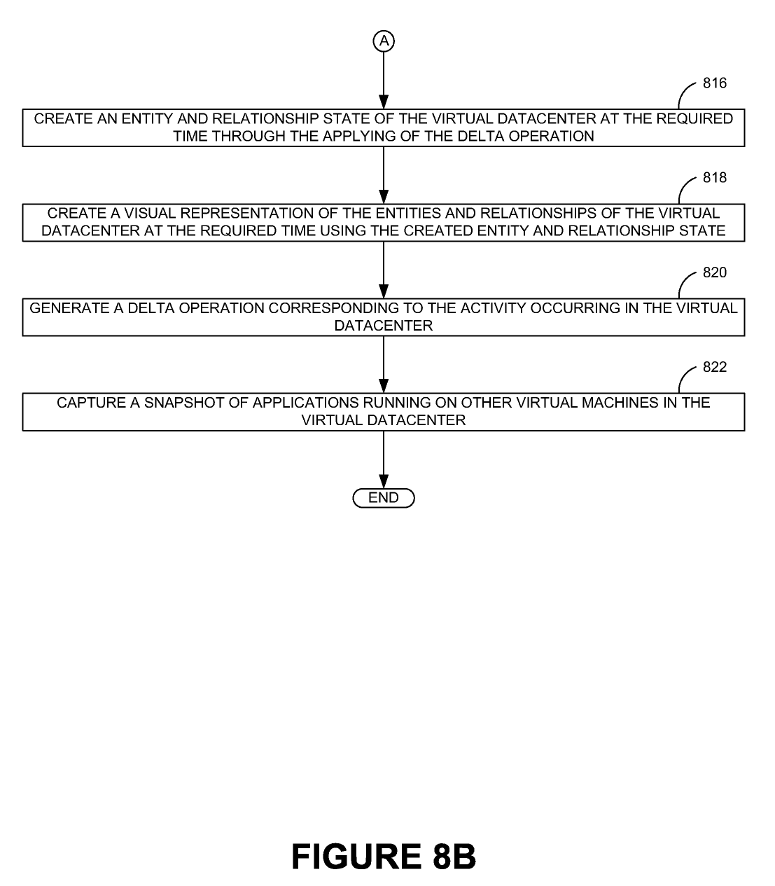

FIG. 8A is a process flow illustrating a method to track an event of a virtual datacenter and representing a state of the virtual datacenter in a visual format, according to one or more embodiments. In operation 802, a snapshot comprising of entities and relationships of a virtual datacenter (e.g., the virtual datacenter 104 of FIG. 1) may be periodically captured from an application programming interface (API) (e.g., the API 218 of FIG. 2) of a management server (e.g., the management server 102 of FIG. 1). In operation 804, an information of the snapshot that is relevant to visualization of a state of the virtual datacenter 104 may be identified in a log file (e.g., the log file 302 of FIG. 3). In operation 806, an activity of a change in entities and relationships of the virtual datacenter 104 may be tracked (e.g., using the track module 210 of FIG. 2).

In operation 808, an event may be registered (e.g., using the register module 206 of FIG. 2) with the management server 102 through the application programming interface 218. In operation 810, delta operation may be created (e.g., using the create module 212 of FIG. 2) based on the event and added in the log file. In operation 812, a nearest snapshot to a required time may be accessed from the log file 302. In operation 814, the delta operation may be applied to the nearest snapshot.

FIG. 8B is the continuation of the process flow illustrated in FIG. 8A with additional embodiments, according to one or more embodiments. In operation 816, an entity and relationship state of the virtual datacenter 104 at the required time may be created by applying delta operation. In operation 818, a visual representation of the entities and relationships of the virtual datacenter 104 at the required time may be created using the created entity and relationship state. In operation 820, a delta operation may be generated corresponding to the activity occurring in the virtual datacenter 104.

In operation 822, a snapshot of applications running on virtual machines [not sure why other is needed here] in the virtual datacenter 104 may be captured. The snapshot 304A-N may be taken on a periodic basis at a threshold interval. Along with snapshot, the log file 302 will include delta operation of the event occurring in the virtual datacenter 104, according to one embodiment. The delta operation may be an activity of each of the event in the virtual datacenter 104. The virtual datacenter 104 may be a collection of a physical set of a host machine, a virtual machine, a CPU, storage, and a resource pool.

The change in the virtual datacenter 104 may be a change to a host machine, a virtual machine, connection of the virtual machine to the host machine and/or a network configuration. The visual representation of the virtual datacenter 104 may be a chart, a table, and a graph. The event may include creation and/or deletion of a virtual machine, creation and/or deletion of a data store, association and/or disassociation of the virtual machine with a data store.

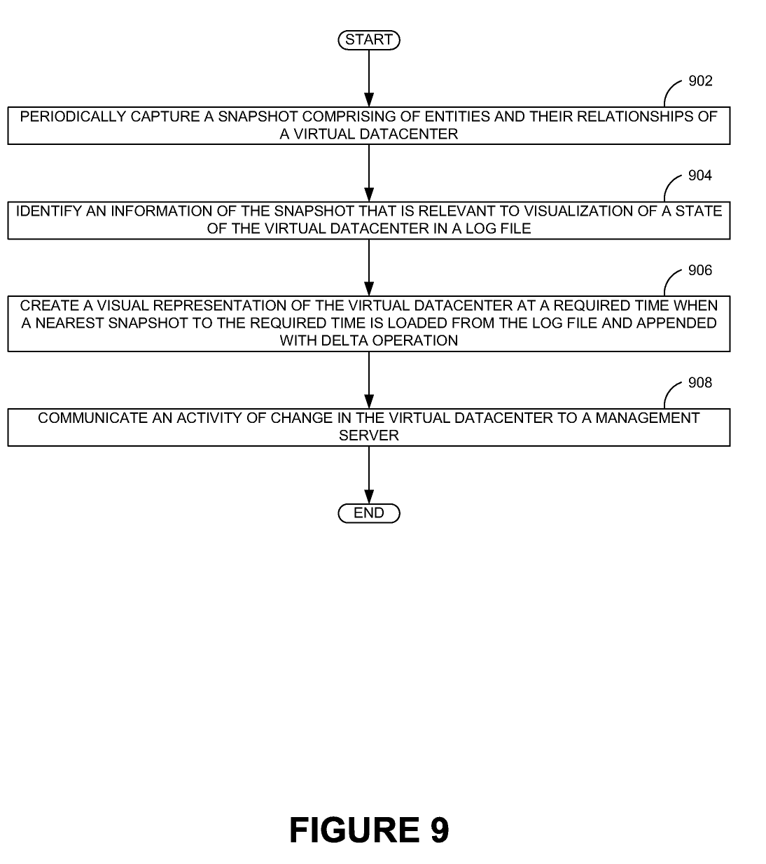

FIG. 9 is a process flow illustrating identification of a change relevant to visualization of the virtual datacenter and communicating the change to the management server, according to one or more embodiments.

In operation 902, a snapshot comprising of entities and their relationships of a virtual datacenter (e.g., the virtual datacenter 104 of FIG. 1) may be periodically captured (e.g., using the capture module 208 of FIG. 2). In operation 904, information of the snapshot that may be relevant to visualization of a state of the virtual datacenter 104 may be identified in a log file (e.g., the log file 302 of FIG. 3). In operation 906, a visual representation of the virtual datacenter 104 at a required time may be created when a nearest snapshot to the required time is loaded from the log file 302 and appended with delta operation. In operation 908, an activity of change in the virtual datacenter 104 may be communicated (e.g., using the communication module 216 of FIG. 2) to a management server (e.g., the management server 102 of FIG. 1).

In an example embodiment, the virtual datacenter may be started on January 1^{st} with one host H1 and one virtual machine VM1. H1 may be connected to VM1. Then the log file generated on January 1^{st} may be:
January 1: snapshot: (VM1, H1, VM1→H1)
   A new virtual machine VM2 may be added to host H1 on January 2. Then the log file generated on January 2nd may be:
January 1: snapshot: (VM1, H1, VM1→H1)
January 2: delta operation: VM2 added to H1
   A new datastore DS may be added to host H1 on January 20. Then the log file generated on January 20 may be:
January 1: snapshot: (VM1, H1, VM1→H1)
January 2: delta operation: VM2 added to H1
January 20: delta operation: DS added to H1
   Now if the snapshot dump period is 30 days, on January 30^{th} the snapshot may be dumped into the log file. The log file generated on January 30^{th} may be:
January 1: snapshot: (VM1, H1, VM1→H1)
January 2: delta operation: VM2 added to H1
January 20: delta operation: DS added to H1
January 30: snapshot: (VM1, VM2, DS, H1, VM1→H1, VM2→H1, DS→H1)
   Similarly on February 30^{th} the log file generated may be:
January 1: snapshot: (VM1→H1)
January 2: delta operation: VM2→H1
January 20: delta operation: DS →H1
January 30: snapshot: (VM1, VM2, DS, H1, VM1 →H1, VM2→H1, DS→H1)
February 3: delta operation: Host H2 added
February 15: delta operation: VM5 added to Host H2
February 19: delta operation: VM2 deleted
February 30: snapshot: (VM1, VM5, DS, H1, H2, VM1→H1, DS→H1, VM5→H2)
   Now if a user ‘Janes’ requires visual representation of state on February 15, then the invention would use the log file as follows:
Step 1: Load the nearest snapshot to February 15. This happens to be January 30.
Step 2: Apply the delta operations till February 15 to reach the state at February 15.
   After running these steps, the invention would reach the state:
(VM1, VM2, VM5, DS, H1, H2, VM1→H1, VM2→H1, DS→H1, VM5→H2)
   This state may be rendered visually.
   If someone were to use the traditional log file, because of absence of periodic snapshots and the other clutter, it would be extremely inefficient to reach the state at a required time as the log file may contain history of few years.

In another embodiment a new special kind of log file may created that may include information of an activity of change in the virtual datacenter (e.g., a change in configuration of a virtual machine, addition of a resource pool, a change in network configuration, etc.). In an alternate embodiment, any existing log file can be used so long as the log file includes information of an activity of change in the virtual datacenter.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the register module 206, the capture module 208, the track module 210, the create module 212, the append module 214, and the communication module 216 of FIG. 2 may be enabled using software and/or using transistors, logic gates, and electrical circuits (e.g., application specific integrated ASIC circuitry) such as a register circuit, a capture circuit, a track circuit, a create circuit, an append circuit, and a communication circuit.

In one or more embodiments, programming instructions for executing above described methods and systems are provided. The programming instructions are stored in a computer readable media.

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The embodiments of the present invention can also be defined as a machine that transforms data from one state to another state. The transformed data can be saved to storage and then manipulated by a processor. The processor thus transforms the data from one thing to another. Still further, the methods can be processed by one or more machines or processors that can be connected over a network. The machines can also be virtualized to provide physical access to storage and processing power to one or more users, servers, or clients. Thus, the virtualized system should be considered a machine that can operate as one or more general purpose machines or be configured as a special purpose machine. Each machine, or virtual representation of a machine, can transform data from one state or thing to another, and can also process data, save data to storage, display the result, or communicate the result to another machine.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic™, JavaScript™, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of Microsoft Windows, Apple Mac, Unix/X-Windows, Linux, etc., executing in a virtualized or non-virtualized environment, using any programming language suitable for desktop software development.

The programming modules and ancillary software components, including configuration file or files, along with setup files required for providing the method and apparatus for troubleshooting subscribers on a telecommunications network and related functionality as described herein may be stored on a computer readable medium. Any computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

One or more embodiments of the invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

What is claimed is:

1. A machine-readable medium embodying a set of instructions that, when executed by a machine, causes the machine to perform a method comprising:
periodically capturing a snapshot comprising of representation of entities and relationships of a virtual datacenter at a point-in-time from an application programming interface of a management server;
identifying an information of the snapshot that is relevant to visualization of a state of the virtual datacenter in a log file;
tracking an activity of a change in the entities and relationships of the virtual datacenter;
registering an event with the management server through the application programming interface;
creating at least one delta operation based on the event and adding delta operation to log file;
accessing a nearest snapshot to a required time from the log file;
applying at least one delta operation to the nearest snapshot;
creating an entity and relationship state of the virtual data center at the required time through the applying of the at least one delta operation; and
creating a visual representation of the entities and relationships of the virtual data center at the required time using the created entity and relationship state.

2. The machine-readable medium of claim 1 further comprising generating a delta operation corresponding to the activity occurring in the virtual datacenter.

3. The machine-readable medium of claim 2 wherein the snapshot is taken on a periodic basis at a threshold interval.

4. The machine-readable medium of claim 3 wherein the delta operation is an activity of each of the event in the virtual datacenter.

5. The machine-readable medium of claim 4 wherein the virtual datacenter is a collection of a physical set of at least one of a host machine, a virtual machine, a CPU, a storage, and a resource pool.

6. The machine-readable medium of claim 1 wherein the change in the virtual datacenter is at least one of a change to a host machine, a virtual machine, connection of the virtual machine to the host machine and a network configuration.

7. The machine-readable medium of claim 1 wherein the visual representation of the virtual datacenter is at least one of a chart, a table, and a graph.

8. The machine-readable medium of claim 1 wherein the log file comprises snapshot of entities and relationships at a point in time in the virtual datacenter.

9. The machine-readable medium of claim 1 wherein the snapshot comprises the point-in-time information of a host, a virtual machine, a data store, a relationship between the virtual machine and a host machine, a relationship between host and the datastore, a relationship between virtual machine and the datastore, a virtual network, a relationship between the virtual machine and the virtual network, and applications running in virtual machine.

10. The machine-readable medium of claim 1 wherein the event comprises creation and deletion of a virtual machine, creation and deletion of a data store, association and disassociation of the virtual machine with a data store.

11. A system comprising:
a virtual datacenter to monitor an activity of a change in the virtual data center;
a network; and
a management server to periodically capture a snapshot comprising of entities and their relationships of the virtual datacenter, to identify an information of the snapshot that is relevant to visualization of a state of the virtual datacenter in a log file, and to create a visual representation of the virtual datacenter at a required time when a nearest snapshot to the required time is loaded from the log file and appended with at least one delta operation.

12. The system of claim 11 wherein the management server to append the information identified through the snapshot to the log file, to track an activity of a change in the virtual datacenter, and to register an event based on the change in the log file.

13. The system of claim 12 wherein the event comprises creation and deletion of a virtual machine, creation and deletion of a data store, association and disassociation of the virtual machine with a data store.

14. The system of claim 12 wherein the change in the virtual datacenter is at least one of a change to a host machine, the virtual machine, connection of the virtual machine to the host machine and a network configuration.

15. The system of claim 14 wherein the virtual datacenter is a collection of physical set of a host machine, a virtual machine, a CPU, a storage, and a resource pool.

16. The system of claim 11 wherein the snapshot comprises the point-in-time information of a host, a virtual machine, a data store, a relationship between the virtual machine and a host machine, a relationship between host and the datastore, a relationship between virtual machine and the datastore, a virtual network, a relationship between the virtual machine and the virtual network, and applications running in virtual machine

17. The system of claim 11 wherein the visual representation of the virtual datacenter is at least one of a chart, a table, and a graph.

18. A machine-readable medium embodying a set of instructions that, when executed by a machine, causes the machine to perform a method comprising:
periodically capturing a snapshot comprising of entities and their relationships of a virtual datacenter;
identifying an information of the snapshot that is relevant to visualization of a state of the virtual datacenter in a log file;
creating a visual representation of the virtual datacenter at a required time when a nearest snapshot to the required time is loaded from the log file and appended with at least one delta operation; and
communicating an activity of change in the virtual datacenter to a management server.

19. The machine-readable medium of claim 18 wherein the snapshot comprises the point-in-time information of a host, a virtual machine, a data store, a relationship between the virtual machine and a host machine, a relationship between host and datastore, a relationship between virtual machine and datastore, a virtual network, a relationship between the virtual machine and the virtual network, and applications running in virtual machine.

20. The machine-readable medium of claim 18 wherein the virtual datacenter is a collection of physical set of a host machine, a virtual machine, a CPU, a storage, and a resource pool.
